(19) United States
(12) Patent Application Publication
(10) Pub. No.: US 2009/0177834 A1
(43) Pub. Date: Jul. 9, 2009

(54) METHOD FOR MANAGING DATA INTENDED TO BE WRITTEN TO AND READ FROM A MEMORY

(75) Inventor: Florent Colliau, Chambon Sur Cisse (FR)

Correspondence Address: LOWE HAUPTMAN & BERNER, LLP, 1700 DIAGONAL ROAD, SUITE 300, ALEXANDRIA, VA, 22314, US

(73) Assignee: Thales, Neuilly Sur Seine (FR)

(21) Appl. No.: 12/160,060

(22) PCT Filed: Jan. 3, 2007
(86) PCT No.: PCT/EP07/50048

§ 371 Date: Oct. 20, 2008

(30) Foreign Application Priority Data
Jan. 3, 2006 (FR) 06/00030

(51) Int. Cl. G06F 12/02; G06F 12/00

(52) U.S. Cl. 711/103; 711/E12.001; 711/E12.008

(57) ABSTRACT

The invention relates to a method for managing data intended to be written to and read from a memory of FLASHPROM type organized into pages. Several data are stored per page and the method consists:
for each page, in reserving an area intended to receive the status and the number of the page,
for each data item, in reserving an area for the status and the size of the data item.

Moreover, at least one page allowing the defragmentation of the memory is reserved.

### CROSS-REFERENCE TO RELATED APPLICATIONS

The present Application is based on International Application No. PCT/EP2007/050048, filed on Jan. 3, 2007, which in turn corresponds to French Application No. 06/00030 filed on Jan. 3, 2006, and priority is hereby claimed under 35 USC §119 based on these applications. Each of these applications are hereby incorporated by reference in their entirety into the present application.

### FIELD OF THE INVENTION

The invention relates to a method for managing data intended to be written to and read from a memory.

### BACKGROUND OF THE INVENTION

Electronic systems requiring software generally need three types of remanent information for their operation: on the one hand programs and data accessible in read-only mode and on the other hand data accessible in read and write mode.

One solution consists in using memories of different types depending on whether the information has to be read only or whether the information has to be written, read and modified.

In the first case, read-only, use is made of fast programmable read-only memories, well known by the name “FlashPROM”. Memories of FlashPROM type are particularly well suited. These are very fast read-only memories allowing the storage of a large volume of information on a small surface area. These memories consume little electrical energy. This type of memory is organized into blocks called pages and, during operation, it is possible to erase the stored information only by erasing at least one entire page. It is not possible to erase just part of a page. Memories of FlashPROM type are not suited to the storage of data intended to be modified during operation when these data are of smaller size than the size of a page. Memories of FlashPROM type, the size of whose pages lies between 1 and 10 kilobytes, are easily obtained. It is therefore understood that this type of memory is not suitable for data of a few bytes and which is intended to be modified.

The invention is not concerned with the dynamic data customarily stored in a random-access memory well known by the name RAM. The invention is concerned with the data having a low occurrence of reading, writing and erasure. Logs of faults arising in an electronic system may be cited by way of example.

For such data, it is possible to use electrically erasable read-only memories well known by the name “EEPROM”. These are read-only memories allowing the storage, the erasure and the rewriting of individual data of variable sizes. Relative to memories of FlashPROM type, memories of EEPROM type are not as fast, have smaller capacity and consume more electrical energy.

### SUMMARY OF THE INVENTION

The invention is aimed at allowing the storage of data of variable size that one wishes to read, write and erase or modify in a memory of FlashPROM type.

For this purpose, the subject of the invention is a method for managing data intended to be written to and read from a memory, characterized in that the memory is of FLASHPROM type organized into pages, in that several data are stored per page and in that it consists:
for each page, in reserving an area intended to receive the status and the number of the page,
for each data item, in reserving an area for the status and the size of the data item.

The principle of the invention relies essentially on managing particular headers in the memory, headers for each page and for each data item within the pages.

The implementation of the invention makes it possible to dispense with the memory of EEPROM type by storing the data that it contains on another memory for example already partially used to store the program allowing the operation of an electronic system. Consequently, the invention makes it possible to reduce the number of components present in the electronic system and to reduce its electrical consumption.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 represents a header of a page of a memory of FlashPROM type;

FIG. 2 represents the structure of a data item intended to be stored on the page represented in FIG. 1;

FIG. 3 represents a flowchart for preparing a page;

FIG. 4 represents a flowchart for searching for an available page;

FIG. 5 represents a flowchart for searching for room available to write a new data item;

FIG. 6 represents a flowchart for detecting a full page;

FIG. 7 represents a flowchart for detecting a full memory;

FIG. 8 represents a flowchart for writing a data item;

FIG. 9 represents a flowchart for deleting a data item;

FIG. 10 represents a flowchart for reading a data item;

FIG. 11 represents a flowchart for defragmenting the memory;

FIG. 12 represents a flowchart for detecting a defragmentation in progress;

FIG. 13 represents a flowchart for verifying the consistency of the content of the memory;

### DETAILED DESCRIPTION OF THE INVENTION

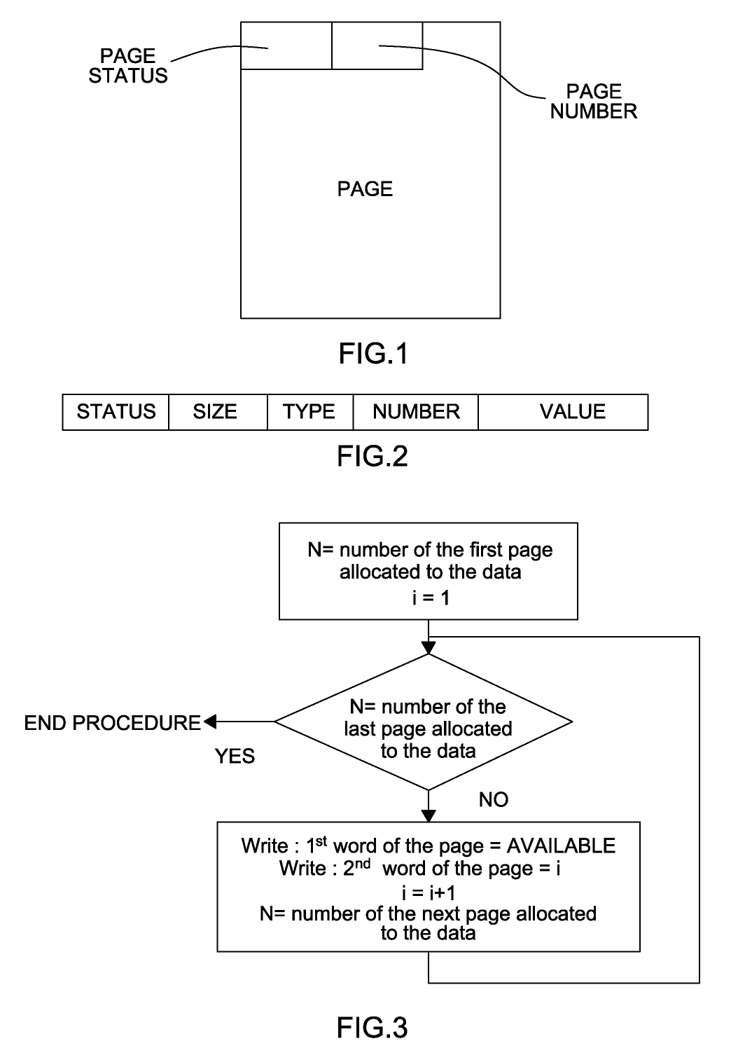

FIG. 1 represents a page of a memory of FlashPROM type in which the invention is implemented. As seen previously, only a part of the memory can be allocated to the storage of data. It is nevertheless considered that several pages of the memory are intended to receive data. At the start of each page envisaged for this purpose, an area of fixed size making it possible to receive the status and the number of the page is reserved. The status of each page can take a number N of values. A feature of the FlashPROM memory is the possibility of writing a value unitarily once. To modify or erase this value it is necessary to erase the whole of the page in which the value has been stored. To alleviate this difficulty, the N values follow one another sequentially and are coded on N-1 bits. For example, the status of the page takes the following five values: EMPTY, COPY, ERASURE, AVAILABLE, FULL. The meaning of these values will be seen subsequently. The values are coded on four bits. Advantageously a transition between two successive values is made by modifying a bit without erasure. On initializing the memory all the bits are for example set to 1 and the value “EMPTY” is therefore expressed as 1111. It is possible to modify this value which becomes COPY by modifying the last bit. COPY is therefore expressed as 1110. Thereafter the value becomes ERASURE by changing the penultimate bit so as to be expressed as 1100. Likewise AVAILABLE is expressed as 1000 and FULL is expressed as 0000.

Advantageously, the number of the page can be structured like the status so as to be able to be modified.

FIG. 2 represents the structure of a data item intended to be stored on the page represented in FIG. 1. An area of fixed size making it possible to receive the status and the size of the data item is reserved at the start of the area making it possible to receive the data item. The status of the data item is managed in the same manner as that of the page. By way of example, the status of the data item takes for example the following four values: FREE, IN PROGRESS, OCCUPIED and DELETED. These four values are coded on three bits and follow one another sequentially. Subsequent to the size, an area making it possible to store the name of the data item may be provided. In the example given in FIG. 1 this name is formed of two items of information: type and number. Finally subsequent to the name of the data item an area is provided to receive the value of the data item.

FIG. 3 represents a flowchart for preparing a page. This flowchart is used during the first booting of the device containing the memory. The method modifies the status of each page allocated to the data item storage so as to place the value AVAILABLE therein, with the exception of the last page which will be used for the defragmentation of the memory. Moreover the method numbers the various pages chronologically. The status and the number of the page form the first two words of the page.

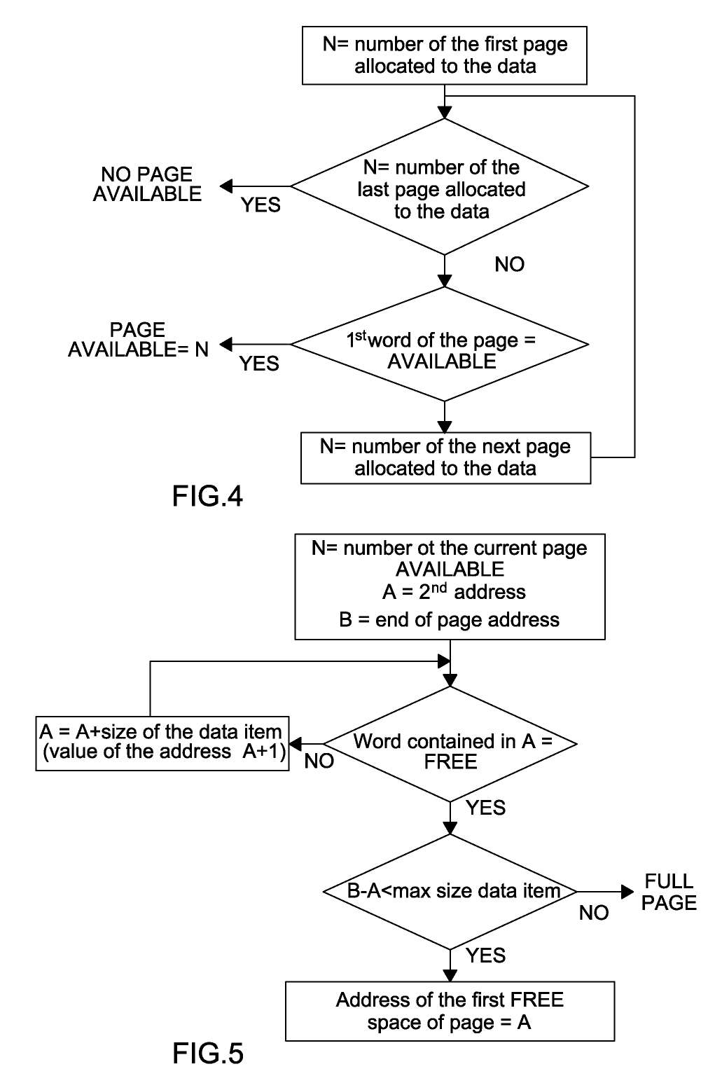

FIG. 4 represents a flowchart for searching for an available page by chronologically searching through the pages allocated to the storage of the data for the first page containing the word AVAILABLE.

FIG. 5 represents a flowchart for searching for room available to write a new data item. This search is made in the page selected with the aid of the flowchart of FIG. 4. As seen previously, the pages are initialized by setting all the bits to 1. Taking the example described with the aid of FIG. 2 where the status of each data item can take four values and is therefore coded on three bits. The convention will be adopted that the value FREE is coded 111. The value FREE therefore represents the first location of the page that has not yet been used after initializing the page. The search is made by reading the status of each data item of the page by jumping the size of each data item. If the room available at the end of a page “B-A”, is less than the size “Size max data item” of the data item to be written, the page is declared full and the status of the page is modified, going from AVAILABLE to FULL by change of state of a bit of the status of the page.

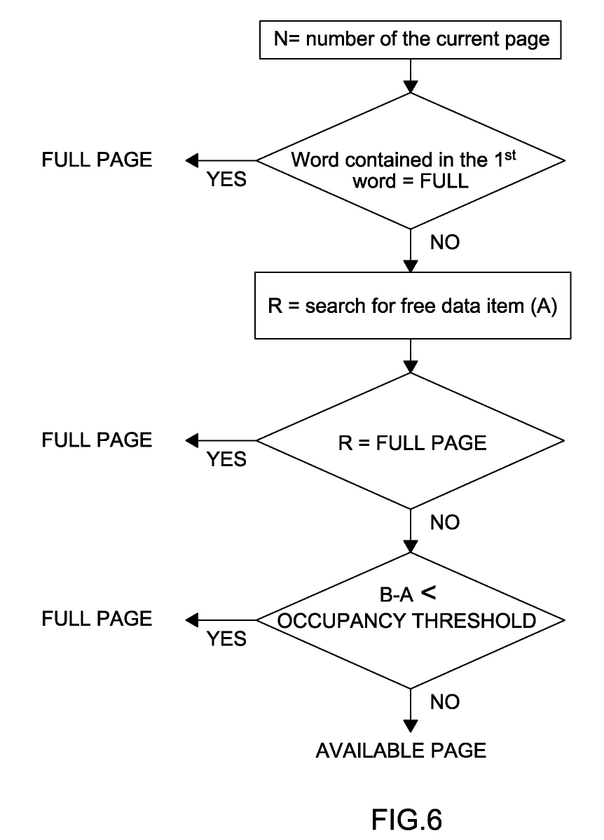

FIG. 6 represents a flowchart for detecting a full page. It is possible to define an occupancy threshold not to be exceeded for each page whose status is AVAILABLE. The flowchart enables, as a supplement to that described in FIG. 5, a page to be declared full.

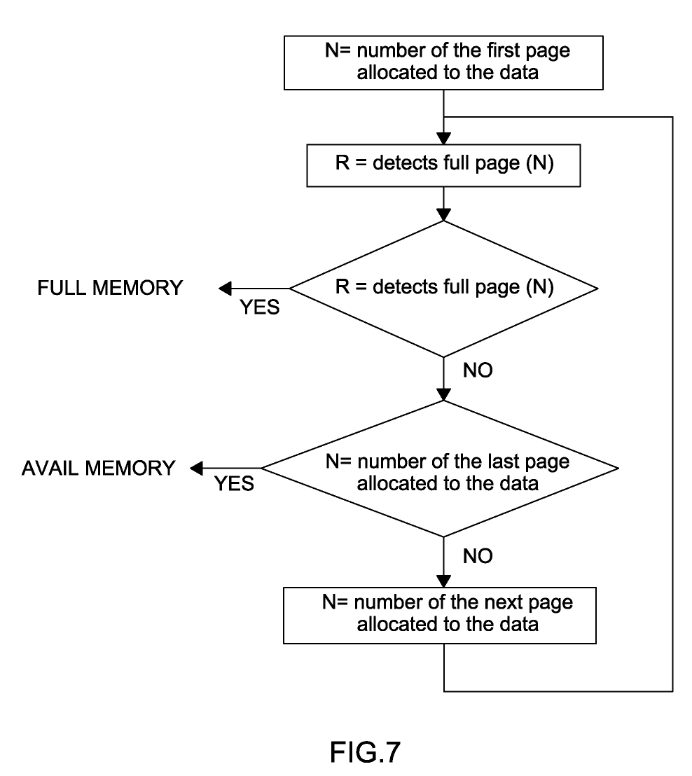

FIG. 7 represents a flowchart for detecting a full memory. The memory is termed full if no further page includes the value AVAILABLE in its status.

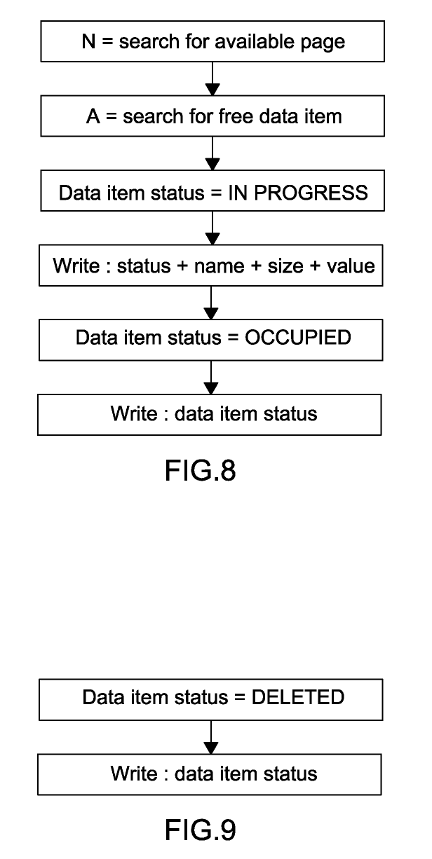

FIG. 8 represents a flowchart for writing a data item at the location chosen. To make the writing of the object secure, the status of the data item is firstly modified, going from FREE to IN PROGRESS, by modifying a bit of the word containing its status. The name, the size and the value of the data item are written thereafter. Then the status is modified, becoming OCCUPIED, again by modifying a bit of the word containing the status. Thus, if a problem occurs while the writing of the data item is in progress, the status will retain the value IN PROGRESS, signifying that the data item has not terminated its writing phase and is therefore invalid. Alternatively, it is also possible to use the type information of the data item, illustrated in FIG. 2, to be certain of the correct writing of the data item. The type takes for example a value “UNKNOWN” at the start of writing and is modified by changing a bit at the end of writing if the latter has been done correctly.

FIG. 9 represents a flowchart for deleting a data item. This algorithm is used as a function of the application if the value of a data item is modified. The FlashPROM memory not allowing the updating of a value, apart from the change of state of a bit in one direction only, if the value of a data item has to vary, the previous location of the data item is abandoned by modifying its status which becomes DELETED by modifying a bit of the word containing the status, and the new value of the data item is written at another available location by means of the flowchart of FIG. 8.

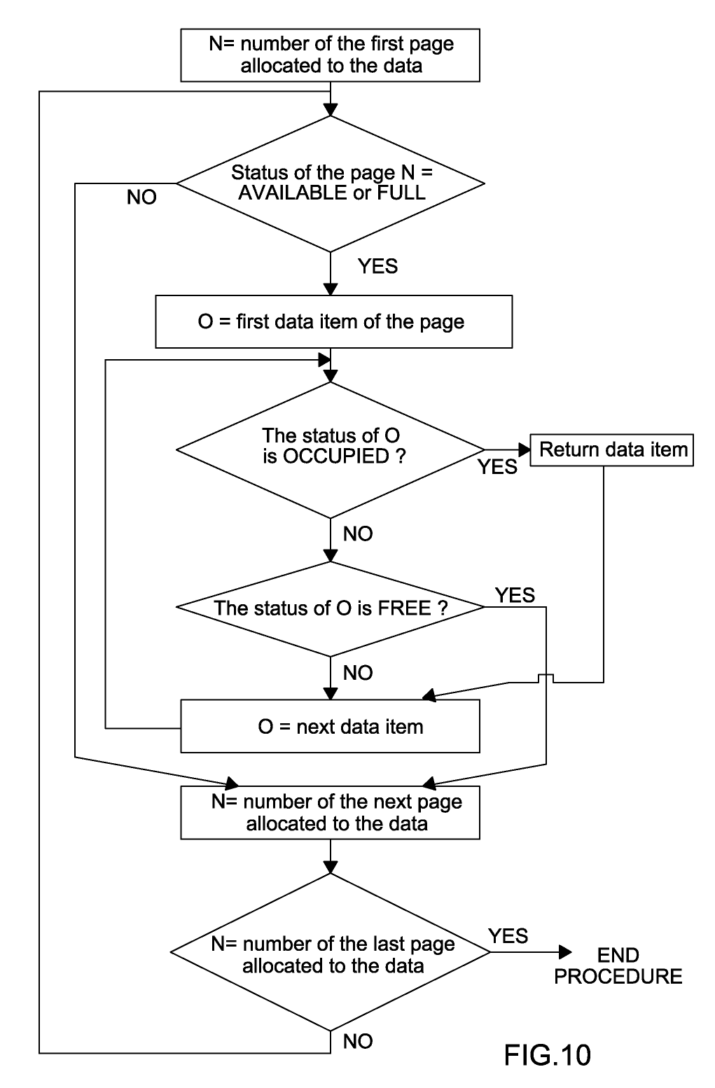

FIG. 10 represents a flowchart for reading a valid data item. The valid data are those whose status is occupied. This flowchart returns all the valid data present in the memory by scanning all the pages containing data, pages whose status is AVAILABLE or FULL.

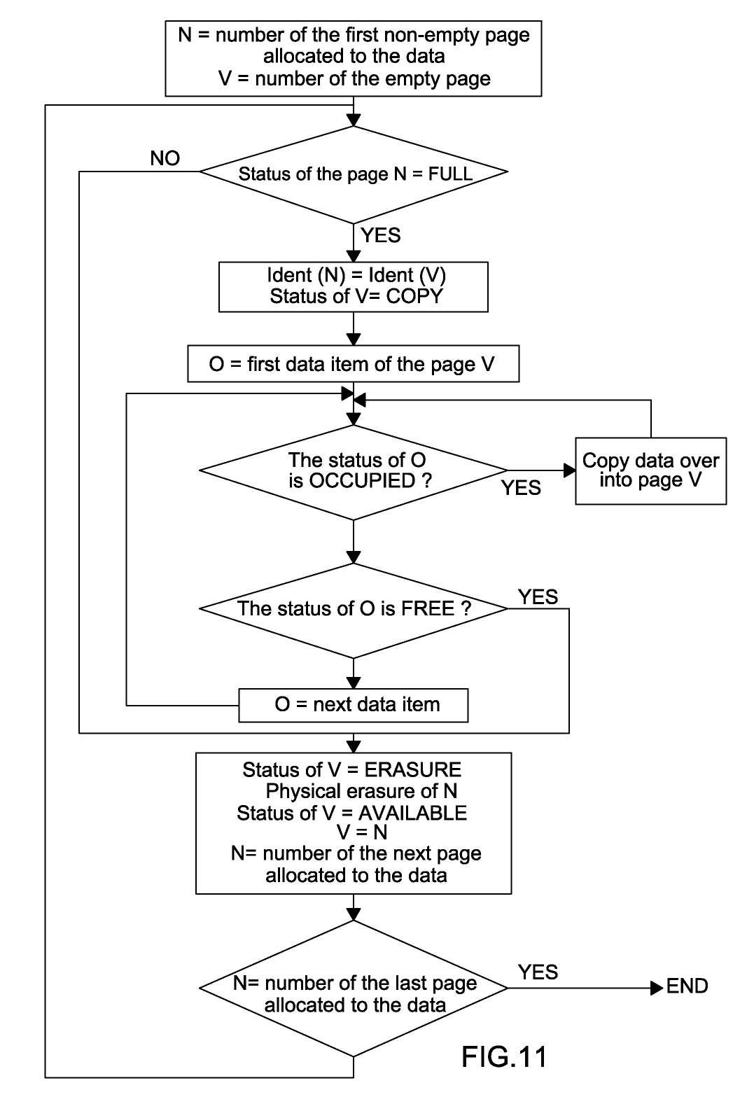

FIG. 11 represents a flowchart for defragmenting the memory. Specifically, as seen with the aid of FIG. 9, a lapsed data item continues to occupy an area of the memory. The flowchart of FIG. 11 makes it possible to group the valid data together by eliminating the lapsed data, that whose status is DELETED. This flowchart uses the last page left free and whose status is EMPTY to copy over from a page whose status is FULL the valid data whose status is OCCUPIED, then the whole of the page whose status is FULL is erased, so becoming a new page reserved for defragmentation. More precisely, the status EMPTY is modified, becoming COPY. The number of the selected page whose status is FULL is modified with the number of the page whose status is COPY. The data whose status is OCCUPIED are copied over from the page whose status is FULL to the page whose status is COPY. The status COPY is modified to ERASURE. The whole of the page whose status is FULL is erased. Finally the status ERASURE is modified to AVAILABLE.

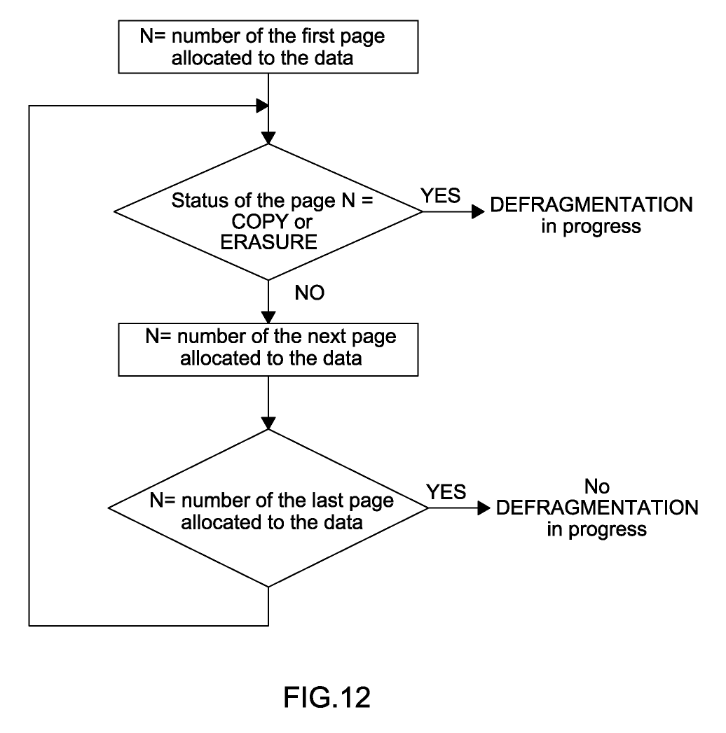

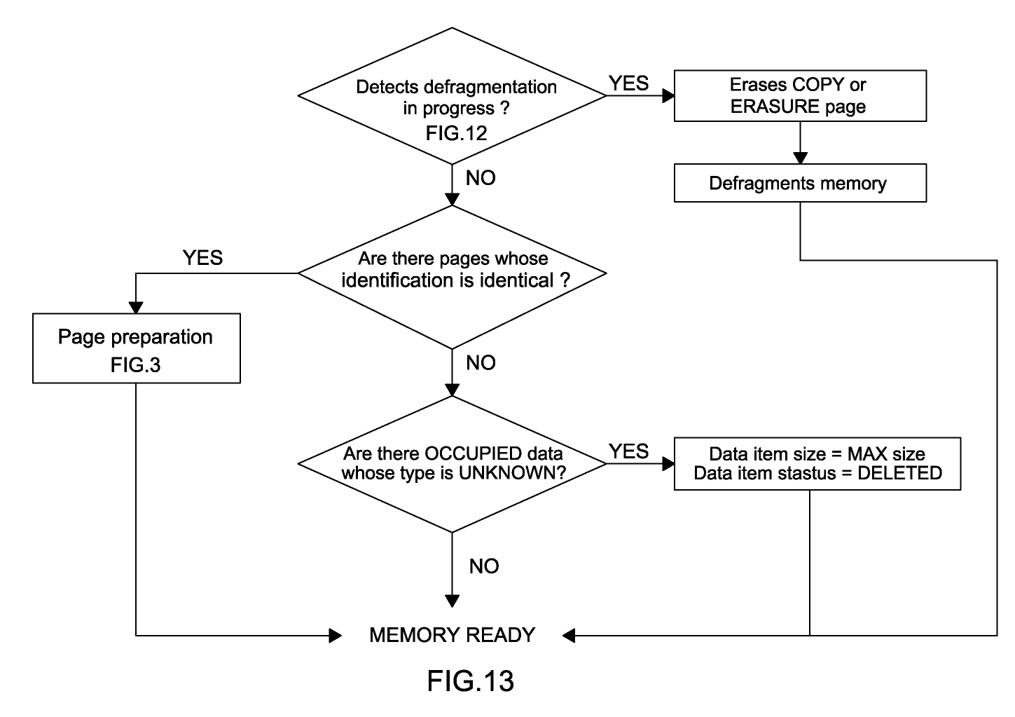

FIG. 12 represents a flowchart for detecting a defragmentation in progress. This flowchart is used when starting up a system operating with the method of the invention. This flowchart makes it possible to know whether a defragmentation has been interrupted during a system stop. A defragmentation is detected if the status of a page is COPY or ERASURE.

It is possible to avoid defragmentations while an operation is in progress and for example to impose a defragmentation at the start of an operation by defining a page occupancy threshold beyond which the status of a page goes from AVAILABLE to FULL. The occupancy threshold is defined so as to allow the storage of all the data written between two activations of the system.

To avoid the case in which the memory is full and defragmentation impossible through the absence of any lapsed data item, it is necessary to provide a sufficient number of memory pages to obtain a few lapsed data before total occupancy of the memory.

FIG. 13 represents a flowchart for verifying the consistency of the content of the memory. Each time the system is booted, the method verifies the consistency of the memory by deleting all the data whose type is UNKNOWN and by fixing their size, if the latter is not advised, at the maximum size of the data. This deletion is carried out by modifying the status of the data item, which becomes DELETED. The method orders a defragmentation if the memory is full or if it was in progress when the system was last deactivated. The method also erases the content of a page whose number would be identical to that of another page. This would be the case when a system deactivation occurs while preparing a page.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A method for managing data intended to be written to and read from a FLASHPROM type memory, organized in pages, wherein several data are stored per page comprising the steps of:
for each page, in reserving an area intended to receive the status and the number of the page,
for each data item, in reserving an area for the status and the size of the data item. and wherein at least one page allowing the defragmentation of the memory is reserved.

2. The method according to claim 1, wherein during a defragmentation, the valid data of a full page are copied over into the page reserved for defragmentation, then the whole of the full page is erased and becomes a new page reserved for defragmentation.

3. The method according to claim 1, wherein the status of each page or of each data item can take a number N of values, in that the values follow one another sequentially and are coded on N-1 bits.

4. The method according to claim 3, wherein a transition between two successive values is made by modifying a bit without erasure.

5. The method according to claim 2, wherein the status of each page or of each data item can take a number N of values, in that the values follow one another sequentially and are coded on N-1 bits.

6. The method according to claim 5, wherein a transition between two successive values is made by modifying a bit without erasure.
